(19) United States
(12) Patent Application Publication
(10) Pub. No.: US 2025/0023403 A1
(43) Pub. Date: Jan. 16, 2025

(54) ELECTRIC MOTOR AND HANDWHEEL ACTUATOR ASSEMBLY INCOPORATING A MOTOR

(71) Applicant: ZF Automotive UK Limited, Solihull (GB)

(72) Inventor: David Julian Moule, Birmingham (GB)

(21) Appl. No.: 18/765,451

(22) Filed: Jul. 8, 2024

(30) Foreign Application Priority Data
Jul. 10, 2023 (GB) 2310577.8

(51) Int. Cl. H02K 1/18; B62D 5/00; H02K 7/116

(52) U.S. Cl. CPC H02K 1/185; B62D 5/006; H02K 7/1166

(57) ABSTRACT

A motor includes a stator and a rotor. The stator carries a plurality of phase windings and the rotor carries a plurality of magnet poles. The stator has a stack of laminations which each have a ferromagnetic plate. Each lamination includes at least one hole within the plate that is aligned with a corresponding hole in adjacent plates in the stack. At least one electrically conductive pin extends axially along a length of the stator passing through the aligned holes to provide a path for currents axially along the stator.

### RELATED APPLICATIONS This application claims priority from GB Patent Application 23105778. filed 10 July 2023. the entirety of which is hereby incorporated herein by reference.

### TECHNICAL FIELD

This invention relates to electric motors and to a handwheel actuator assembly for use in a steer by wire system of a vehicle incorporating an electric motor.

### BACKGROUND

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications is in steer-by-wire systems. During normal use, these systems have no direct mechanical link from the hand wheel that the driver moves and the steered wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary electric motor coupled to the steering wheel. The secondary motor provides the driver with the appropriate resistance and feedback in response to specific user inputs at the steering wheel to mimic the feel of a conventional steering system. This secondary motor is connected to a shaft that supports the handwheel through a gearset, and those three parts collectively form a Handwheel Actuator Assembly.

The motors in a steer by wire system are typically constructed with a stator that comprises laminations stacked together in the axial direction. This is both a cost-effective way to manufacture the motors, but also by applying an electrically insulating coating between each lamination in the stack currents are prevented from flowing axially through the stator. This reduces energy losses within the motor that would otherwise result from current flowing axially in the stator. Such a prior art motor construction exhibits a low level of drag torque from the elimination, or severe restriction, of the current that flows axially. The laminations are commonly locked together by interlocks that are stamped into the otherwise flat plates as shown in the example of FIG. 9. During assembly the plates are stacked up with the interlocks aligned and then pressure is applied to push the interlocks into engagement. The interlocks in the final stator nest together to hold the stack together axially, prevent the laminations from sliding over one another and also act as a guide when aligning the plates on assembly.

The term drag torque as used in this description means a torque that is generated by the motor when it is rotating that opposes any torque that is applied to drive the motor. The rotor of a motor which has all of its phases open circuit with virtually zero drag torque can be spun with only a small amount of external torque applied, one with a very high drag torque will require an equally high or higher external torque to make the rotor rotate.

In a steer-by-wire system, a malfunction or failure of a portion of the assembly may impair the ability to steer the vehicle. As a result, it is desirable to provide the assembly with structure for providing at least temporary fail-safe operation. US 2006/0042858 A1 discloses steering apparatus including a steering assembly that includes a handwheel actuator. The handwheel actuator includes a steering column for supporting a steering wheel, a gear mechanism and two motors, each for providing a torque to the steering column. Single motor handwheel actuator assemblies are also known.

When the steer by wire system is powered up and functioning correctly, the HWA imposes torque on the shaft carrying the handwheel that resists the driver turning the steering wheel shaft. For much of the operation of the system, the motor or motors within the handwheel actuator operate as a controlled resistance to the driver. This can be used to give the driver a feel for what is happening at the interface between the road wheels and the road surface that has otherwise been lost with the removal of the mechanical link from the handwheel to the road wheels.

It is undesirable for the hand wheel to be able to rotate freely and a small amount of resistance to movement, which the driver can always overcome is always desirable. Preferably, this resistance to motion is either constant or proportional to the handwheel speed to enable a good steer-feel. In the prior art it is known to provide resistance to movement by absorbing energy within the motor drive electronics using a principle known as braking torque. A braking torque is created when there is at least one closed circuit through the motor phases in which current generated as the motor rotates will flow. This requires active control of the motor drive circuit to operate-typically close-appropriate phase switches and force the closed circuit in the motor. The applicants have also appreciated that it is desirable to have minimum electrical connections to the motor and to avoid the use of auxiliary windings and connected controllers to create the resistance to motion in the event of a fault within the system

The applicants have appreciated that it is desirable that this resistance should be present even if the electrical power is removed from the system. Where the resistance is achieved by application of appropriate currents to the motor, this resistance will be removed in the event of a fault where currents cannot be supplied or generated within the motor.

### SUMMARY

An object of the present invention is to provide a motor and a handwheel actuator assembly incorporating such a motor that provides a desirable level of resistance to rotation when the motor is not powered.

According to a first aspect the invention provides a motor comprising a stator and a rotor, the stator carrying a plurality of phase windings and the rotor carrying a plurality of magnet poles; and
in which the stator comprises a stack of laminations which each comprise a ferromagnetic plate, each lamination including at least one hole within the plate that is aligned with a corresponding hole in adjacent plates in the stack, and further comprising at least one electrically conductive pin that extends axially along a length of the stator passing through the aligned holes to provide a path for currents axially along the stator.

Every lamination may include at least one hole aligned with the hole in every adjacent lamination such that the pin extends axially through the whole of the stack of laminations.

The motor within the scope of the invention can support a combination of eddy current and hysteresis loss within the stator and therefore provide a resistance to rotation. These currents can flow axially because of the use of a stack of laminations that are pinned together to allow currents to flow axially through the pin along the stator. This provides for good levels of eddy currents within the stator providing the electrical losses needed to oppose rotation of the shaft when the motor is not being driven but can be readily manufactured using typical lamination stamping processes for high volume manufacture of electric motors. The stamping process is simpler as the detailed interlock features are not needed. The axial length of the resulting stack can be accurately controlled by the interlocking pins.

The pin may comprise an elongate rod of metal or metal alloy. It may have a circular cross section.

Preferably the pin is made from steel to maintain the radial and circumferential magnetic properties of the lamination stack along with the axial electrical conductivity

Preferably the laminations are in tight contact with the conductive pin.

The pin may have an interference fit with at least two plates to hold those plates together. These plates may be the upper most and lowermost plates in the stack.

The pin may have an interference fit with every plate in the stack.

Preferably the pin has features e.g. splines that cut in to the laminations to enhance the electrical conductivity, the splines cutting into the sides of the holes in the plates.

Preferably the pin is deformed at one or both ends to act as rivets holding the lamination stack together.

Preferably each plate includes a second hole which is aligned with a corresponding second hole in adjacent plates and the motor further includes a second pin which passes through the aligned second holes. to enhance the electrical conductivity and mechanical stability of the assembly. The two pins may be spaced in diametrically opposed locations on the stator.

It is most preferred that each plate contains many more than two holes to allow more than two pins to be used.

Providing at least two pins allows for a large area for magnetic flux to be encircled by the conductive path that includes the two pins.

The stator may comprise a yoke from which a plurality of teeth project. One or more holes may be formed in an end portion of every tooth of the stator aligned with corresponding holes in adjacent teeth. One or more holes may be formed in the yoke portion of the stator between each tooth aligned with corresponding holes in other plates.

The laminations may be coated with an insulating material or may not be coated with an insulating material.

The stator laminations can be made using standard lamination stamping, the holes being stamped or cut of the laminations during production.

There may be at least one pin that extends axially through the stator, by which we mean parallel to an axis of rotation of the motor.

Alternatively or additionally there may be at least one pin that extends in a direction which is inclined relative to the axis.

Each pin may be straight, but it is within the scope of the invention for the pin to have a curve with the holes in the plates when aligned following a corresponding curved path.

The motor may comprise a stator that comprises laminations of lossy steel that does not meet the loss (W/kg) requirements of the M470-50A standard.

The steel may comprise a low silicon content steel, and may have less than 1 percent silicon by weight

An example of a steel that may be used to form a plate of the stator of the handwheel actuator assembly of the invention in which the drag torque is generated predominantly due to eddy current losses is a free machining mild steel such as EN1A or ASTM 1215.

An example of a steel that may be used to form a stator of the handwheel actuator assembly of the invention in which the drag torque is generated predominantly due to hysteresis losses is a C75 carbon spring steel which may be provided in the form of 0.5 mm thick sheets.

The steel stator material may have at least 20 times the coercivity, or at least 30 times the coercivity of electrical steel such as M470-50A.

The material from which the stator is manufactured may have a specific total loss when excited with a sinusoidal flux density of amplitude 1 Tesla and frequency of 50 Hz greater than 30 W/kg, when tested according to the ASTM standard A927/A927M—11 (Standard Test Method for Alternating-Current Magnetic Properties of Toroidal Core Specimens Using the Voltmeter-Ammeter-Wattmeter Method).

The motor stator may be configured such that the motor stator assembly excluding copper windings has an effective loss per mass of at least 30 Watts per kg. This is a figure that is greater than any standard electrical steel as used in electrical machines and particularly existing automotive electric assisted steering assemblies.

The motor may be configured to provide at least 60 percent of the resistance to rotation of the output shaft for at least one speed in the range, or at least 70 percent, or 80 percent, or substantially all of the drag torque over a range of non-zero rotational speeds. The motor may provide all or substantially all of the resistance to rotation of the output shaft, by which we mean at least an order of magnitude larger than any resistance provided by mechanical friction present in the motor.

The motor may be configured to provide at least 2 Nm of drag torque over a substantial range of non-zero rotational speeds of the rotor or of an associated output shaft taking account the effect of the gear ratio of any gearset connecting the motor rotor and output shaft.

In accordance with a second aspect of the present invention, there is a mechanical assembly comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which the stator comprises a stack of laminations which each comprise a ferromagnetic plate, each lamination including at least one hole within the plate that is aligned with a corresponding hole in adjacent plates in the stack, and further comprising at least one electrically conductive pin that extends axially along a length of the stator passing through the aligned holes to provide a path for currents axially along the stator.

The motor may include any of the features of the motor of the first aspect of the invention.

The mechanical assembly may include a gearbox comprising a first gear fixed relative to the shaft and a second gear fixed relative to the output of the motor, rotation of the first gear causing a rotation of the second gear.

The two gears may be directly meshed or may be connected to each other through a belt. Where the mechanism is part of a handwheel actuator assembly, the handwheel actuator may comprise a second gear connected to and configured to rotate with the shaft; and a second motor having an output driving a respective second output gear, the second output gear being engaged with the first gear and hence the shaft.

This second motor may also be constructed in accordance with the first aspect of the invention and generate a significant drag torque such that the sum of the drag torque from both motors provides a substantially resistance to the turning of the handwheel when the motor is unpowered.

Alternatively, the second motor may have a more conventional construction using insulated laminated plates of electrical steel as the rotor with no pins so that it does not play a significant role in the overall resistance to rotation when unpowered. The first motor may therefore provide considerably more drag torque compared to the second for instance at least double the drag torque.

The motor may comprise a brushless permanent magnet type motor comprising a rotor and a stator having many windings surrounding regularly circumferentially spaced teeth extending from a yoke.

The shaft may be connectable to a handwheel directly through a splined connector on an end of the shaft fitting in an internally splined connector of the handwheel. The shaft will therefore rotate at the same speed as the handwheel. The motors if directly connected to the shaft will also rotate at the same speed. If the motors are connected to the shaft through a gearbox, they will rotate at a different speed to the handwheel.

Alternatively, the shaft may be connected to the handwheel through a gearbox. In this case the rotational speed of the shaft may differ from the rotation speed of the handwheel.

The motor may form a part of a handwheel actuator assembly of a steer by wire vehicle so constructed and arranged that the motor rotor is connected to a shaft that in turn is connected to a handwheel of the vehicle and the handwheel actuator assembly is configured such that in the event that the control circuit is powered down or disconnected and the handwheel is rotated at 180 degrees per second the combination of motors overall provides a drag torque of at least 50 percent of the resistance to rotation of the shaft and a torque at the handwheel of at least 2 Nm.

The handwheel actuator assembly may comprise two of the motors of the first aspect of the invention, the rotor of each motor being connected to the shaft that in turn is connected to the handwheel.

By providing one or more motors where at least one provides a significant and useful level of drag torque, the driver must apply at least 2 Nm at a handwheel speed of 180 degree/second to maintain a constant speed of rotation of 180 degree/second of the handwheel as that resistance must be overcome before any extra torque is used to accelerate the handwheel. This level of resistance is generally considered acceptable in an automotive handwheel actuator application. If it is too low the steering feels too light and may be too easy to turn at high speeds comprising stability, but if too high it may make the steering so heavy the driver may struggle to turn the wheel and manoeuvre the vehicle. The function of the conducting metal coating is to improve conductivity between adjacent laminations such that it approximates the electrical conductivity of a solid magnetic component, such as a stator stack, thereby promoting larger eddy-currents than would normally be the case with insulated laminations in a stack.

The invention provides a damping of an otherwise uncontrolled rotation without electronics, additional mechanical components or complexity that prevents the steering wheel rotating freely when the power is removed, motor disconnected, or under certain fault conditions that render the control unit electrically inoperative. Removing the need to lose energy in the drive circuit, as is known from the prior art, protects the circuit from damage due to heat build-up and moves the heat loss into the motor where it can better be managed.

According to a third aspect the invention provides a method of constructing an electric motor comprising:
providing a set of laminations, each comprising a plate having at least one hole; and
at least one elongate electrically conductive pin,
assembling the plates in a stack whereby the hole in each plate aligns with a hole in any adjacent lamination, and
Inserting the pin into the stack so that it extends through each of the aligned holes.

The method may comprise securing the pin in location through an interference fit of the pin with at least one lamination, or multiple laminations.

The holes prior to inserting the pin may be undersized relative to the size of the pin such that on inserting the pin at least one of the pin and material surrounding each hole are deformed to provide a secure grip between the pin and the plates.

The method may comprise flaring the ends of the pin after insertion to prevent removal of the pin. One end may already be flared before fitment with only the other end of the pin needing to be flared after the pin has passed through the stack. The pin will therefore be slightly longer that the height of the stack of laminations to allow for a protruding portion that can be flared.

The end or ends of each pin may be flared using a peening hammer of other suitable tool that is able to apply substantial pressure to the end of the pin.

### BRIEF DESCRIPTION OF THE DRAWINGS

There will now be described by way of example only one embodiment of the present invention with reference to and as illustrated in the accompanying drawings of which:

FIG. 1 shows the key mechanical components of an embodiment of a handwheel actuator assembly according to an aspect of the invention that includes a pair of motors that may each fall within a further aspect of the invention;

FIG. 2 shows another embodiment of a handwheel actuator assembly according to an aspect of the invention;

FIG. 3 shows a general arrangement of an electronic control unit which controls the two motors of a dual motor drive assembly according to a first aspect of the invention;

FIG. 4 shows a layout of a Steer-by-Wire system including a dual motor drive assembly according to a first aspect of the invention;

FIG. 5 (a) and (b) are B-H curve plots of flux density, B against Magnetizing force H for a soft steel such as electrical steel and a not so soft steel such as carbon steel;

FIG. 6 is a plot showing the B-H curve for a chosen non-electrical steel used in the motors of the embodiments of FIG. 1 and FIG. 2 against the plot for an electrical steel;

FIG. 7 is a plot showing the increase in overall flux from the motors when constructed using the non-electrical steel versus an electrical steel; and

FIG. 8 shows in cross section the configuration of a motor stator and rotor that may be used in the mechanism of FIG. 1;

FIG. 9 shows in perspective a portion of a stator of a prior art motor in which laminated plates are stacked and secured by three interlocks in each plate;

FIG. 10 shows in perspective a similar portion of a stator arranged as shown in FIG. 8 in which the stack of laminations is secured by three pins that pass through three sets of aligned holes in the plates;

FIG. 11 is a plan view one plate that forms the stator of the motor of FIG. 8 showing the positioning of holes in the plate prior to inserting pins; and

FIG. 12 is an exploded view showing three plates located along one pin, the plates beings separated better to show the pin passing through the holes in each plate.

### DRAWINGS

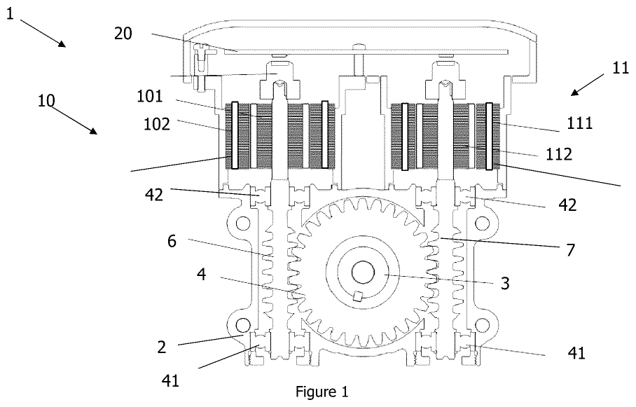

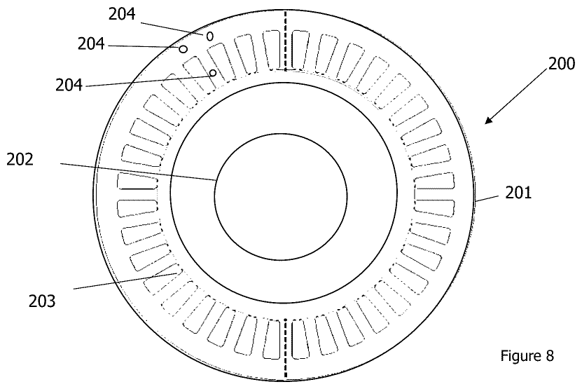

FIG. 1 shows a handwheel actuator (HWA) assembly of a vehicle, according to a first aspect of the invention. This example is a dual motor assembly which has two motors, each connected to a common shaft through a respective gearbox. The invention can be implemented with a single motor and also without the presence of a gearbox by direct connection of the motor rotor to the shaft. The motors have special properties and embody the first aspect of this invention and examples of the motor construction are presented in FIGS. 8 to 11. By describing the motors in relation to one potential use in a handwheel actuator assembly the benefits of these motors over conventional motors in such applications can be readily understood.

The assembly 1 includes a first motor 10 with rotor 101 and stator 102 and a second motor 11 with rotor 111 and stator 112, the first motor 10 being connected to a first worm gear 6 and the second motor 11 being connected to a second worm gear 7. Each worm gear 6, 7 comprises a threaded shaft arranged to engage with a gear wheel 4 connected to a steering column shaft 3 such that torque may be transferred from the worm gears 6, 7 to the gear wheel 4 connected to the steering column shaft 3. The gear wheel 4 is operatively connected to a driver's handwheel (not shown) via the steering column shaft 3. In this example, each of the two motors 10, 11 are brushless permanent magnet type motors and each comprise a rotor 101, 111 and a stator 102, 112 having many windings surrounding regularly circumferentially spaced teeth. The arrangement of the two motors 10, 11, the shaft 3, the worm gears 6, 7 and the wheel gear 4 together form a dual motor electrical assembly.

Each of the two motors 10, 11 are controlled by an electronic control unit (ECU) 20. The ECU 20 controls the level of current applied to the windings and hence the level of torque that is produced by each motor 10, 11.

In this example, the two motors 10, 11 are of a similar design and produce a similar level of maximum torque. However, it is within the scope of this disclosure to have an asymmetric design in which one motor 10, 11 produces a higher level of torque than the other 10, 11.

One of the functions of a handwheel actuator (HWA) assembly is to provide a feedback force to the driver to give an appropriate steering feel. This may be achieved by controlling the torque of the motors 10, 11 in accordance with signals from the handwheel actuator (such as column angle) and from other systems in the vehicle (such as vehicle speed, rack angle, lateral acceleration and yaw rate).

The use of two motors 10, 11 is beneficial in eliminating rattle. If a single electric motor were instead used in a torque feedback unit, the motor may be held in locked contact with the gearing by means of a spring. However, in certain driving conditions the action of a spring is not sufficiently firm, which allows the gears to “rattle” during sinusoidal motions or sharp position changes of the steering column.

Use of two motors 10, 11 which can be actively controlled (as in the present embodiment) ameliorates the problems associated with use of a single motor. In this arrangement, both motors 10, 11 are controlled by the ECU 20 to provide torque feedback to the steering column and to ensure that the worm shafts 6, 7 of both motors 10, 11 are continuously in contact with the gear wheel 4, in order to minimise rattle. The use of two motors 10, 11 in this way also allows active management of the friction and thereby the feedback force to the driver.

As shown in FIG. 1, the motors 10, 11 are received in and secured to a transversely extending two-part extension of a housing 2. The worm shaft 6, 7 of each motor is supported relative to the housing by two sets of bearings. A first set of bearings 41 supports a first end of each worm shaft 6, 7 distal their respective motor 10, 11 while a second set of bearings 42 supports a second end of each worm shaft 6, 7 proximal their respective motor 10, 11.

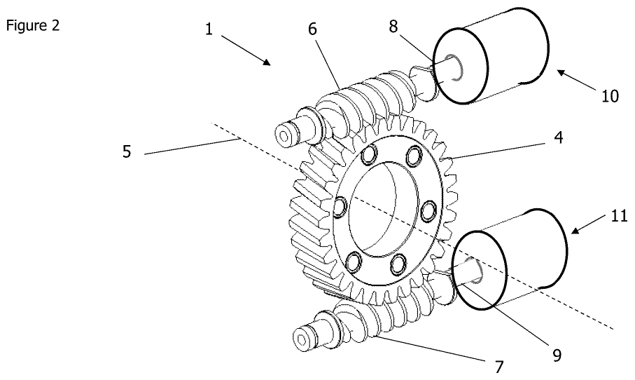

FIG. 2 shows an axis of rotation of the shaft 3 marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to the output shaft 8, 9 of a respective electric motor 10, 11.

The axes of the output shafts 8, 9 of the two motors 10, 11 are arranged perpendicularly to the rotational axis of the shaft 3 and the axes of the two motors may also be inclined with respect to each other, to reduce the overall size of the assembly.

The motors 10, 11 are controlled by the electronic control unit (ECU) 20 such that at low levels of input torque applied to the shaft 3 by the handwheel, the motors 10, 11 act in opposite directions on the gear wheel 4 to eliminate backlash. At higher levels of input torque applied to the shaft 3 by the handwheel, the motors 10, 11 act in the same direction on the gear wheel 4 to assist in rotation of the shaft 3. Here, a motor 10, 11 acting in ‘a direction’ is used indicate the direction of torque applied by a motor 10, 11 to the gear wheel 4.

The use of two separate motors 10, 11 which can be controlled in a first operational mode to apply torque in opposite directions to the gear wheel 4 eliminates the need to control backlash with precision components. In addition, the use of two separate motors 10, 11 which can be controlled in a second operational mode to apply torque in the same direction to the gear wheel 4 allows the motors 10, 11 and gear components 4, 6, 7 to be specified at half the rating of the required total system torque, thereby reducing the size and cost of the drive assembly 1.

In the embodiment shown in FIGS. 1 and 2, the worm shafts 6, 7 engage diametrically opposed portions of a gear wheel 4. The threads of the worm shafts 6, 7 each have the same sense, i.e., they are both left-handed screw threads. The motors 10, 11 are configured such that they lie on the same side of the gear wheel 4 (both motors 10, 11 lie on one side of a virtual plane perpendicular to axes of the worm shafts 6, 7 and passing through the centre point of the gear wheel 4). Considering as an example the perspective shown in FIG. 2, driving both motors 10, 11 clockwise would apply torque in opposite directions to the gear wheel 4, with motor 10 applying a clockwise torque to gear wheel 4 and motor 11 applying an opposing anti-clockwise torque to gear wheel 4.

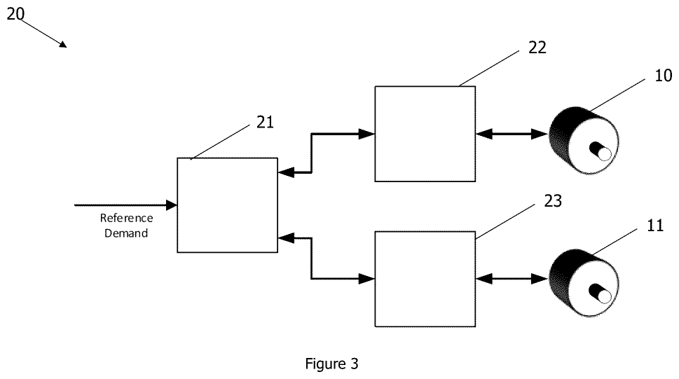

FIG. 2 shows another embodiment of a handwheel actuator assembly 1 according to the first aspect of the invention. This embodiment is substantially similar to the embodiment shown in FIGS. 1 and 2 with the only difference being the positioning of the motors 10, 11. Components and functional units which in terms of function and/or construction are equivalent or identical to those of the preceding embodiment are provided with the same reference signs and are not separately described. The explanations pertaining to FIG. 1 therefore apply in analogous manner to FIG. 3 with the exception of the positioning of the two motors 10, 11.

In FIG. 2 the worm shafts 6, 7 engage diametrically opposed portions of a gear wheel 4 and threads of the worm shafts 6, 7 each have the same sense, i.e., in this example, they are both right-handed screw threads. The motors 10, 11 are configured such that they lie on opposing sides of the gear wheel 4 (motor 10 lies on one side of a virtual plane perpendicular to axes of the worm shafts 6, 7 and passing through the centre point of the gear wheel 4 while motor 11 lies on the other side of this virtual plane).

Application of torque by a driver in a clockwise direction results in rotation of the handwheel 26 and the steering column shaft 3 about the dashed line 5. This rotation is detected by a rotation sensor (not shown). The first motor 10 is then controlled by the ECU 20 to apply torque in the opposite direction. In a first operational mode, the second motor 11 is actuated by the ECU 20 to apply an offset torque 32 in the opposite direction to the torque 30 of the first motor 10 to reduce gear rattling. Alternately, in a second operational mode, the second motor 11 is actuated by the ECU 20 to apply a torque 34 in the same direction to the torque 30 of the first motor 10 to increase the feedback torque to the steering column shaft 3

The net result of the torques by the first and second motors 10, 11 results in an application of a feedback torque to the steering column shaft 3 and handwheel 26, to provide a sensation of road feel to the driver. In this example, the application of a feedback torque is in the opposite direction to that applied to the handwheel 26 by the driver. In this way, the “rattle” produced between the worm shafts 6, 7 and the gear wheel 4 can be eliminated or significantly reduced.

FIG. 3 reveals part of an HWA assembly 80 showing a general arrangement of an electronic control unit (ECU) 20 which controls each of the two motors 10, 11. The ECU 20 may include a hand wheel actuator (HWA) control system 21 as well as a first and second motor controller 22, 23 which control the first and second motors 10, 11 respectively. A reference demand signal is input to the HWA control system 21 which allocates torque demands to each of the first and second motors 10, 11. These motor torque demands are converted to motor current demands and transmitted to the first and second motor controllers 22, 23. Each motor 10, 11 provides operating feedback to their respective motor controller 22, 23. The HWA control system 21 is configured to calculate the magnitude of mechanical friction using the motor torque demands. In another embodiment, the HWA control system 21 may be implemented by a separate ECU to the first and second motor controller 22, 23.

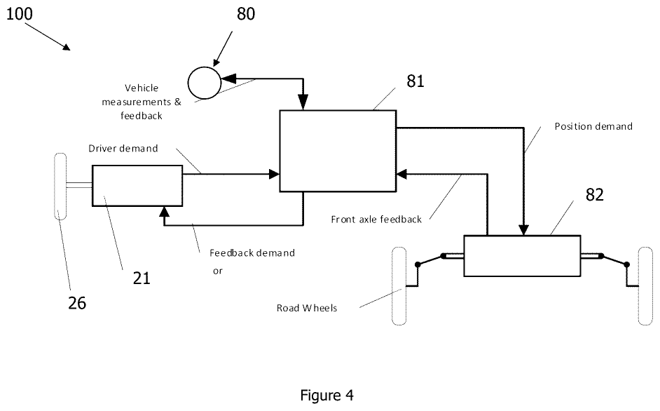

FIG. 4 shows an overall layout of a Steer-by-Wire system 100 for a vehicle including the handwheel actuator (HWA) assembly 80 according to a first aspect of the invention. The HWA assembly 80 supports the driver's handwheel 26 and measures the driver demand which is usually the steering angle. A steering controller 81 converts the driver demand into a position demand that is sent to a front axle actuator (FAA) 82. The FAA 82 controls the steering angle of the roadwheels to achieve the position demand. The FAA 82 can feedback operating states and measurements to the steering controller 81.

The steering controller 81 combines the FAA 82 feedback with other information measured in the vehicle, such as lateral acceleration, to determine a target feedback torque that should be sensed by a driver of the vehicle. This feedback demand is then sent to the HWA control system 21 and is provided by controlling the first and second motors 10, 11 with the first and second motor controllers 22, 23 respectively.

FIG. 4 shows the steering controller 81 as physically separate to both the HWA controller 21 and the FAA 82. Alternately, different architectures, where one or more of these components are physically interconnected, may be used within the scope of this disclosure. For example, the functions of the steering controller 81 may be physically implemented in the HWA controller 21, the FAA 82, or another control unit in the vehicle, or some combination of all 3. Alternatively, control functions ascribed to the HWA controller 21 and FAA 82 may be partially or totally implemented in the steering controller 81.

In the event that there is a fault in the motor windings that prevents any current flowing through the motor, or disconnection of motor from the control electronics, or in the motor drive stage or in the control system, including a loss of electrical power to the handwheel assembly, it becomes impossible to control the rotation of the handwheel by the driver in order to provide feedback. The motors of the handwheel actuator assembly of FIG. 1 are configured in order to ensure that there is some damping of the rotation of the wheel in this condition. This is beneficial as it will feel more natural to the driver and will also help them not make steering inputs at too high a rate by damping their actions.

In a conventional prior art Handwheel actuator assembly the motor is fabricated using a high-performance electrical steel for the stator as it is generally desirable to reduce the level of drag torque and the resulting energy losses. Further reductions are attained by the use of a laminated stator in which electrical steel plates are held apart by interleaved layers of insulating material.

In the embodiment of FIG. 1 and the embodiment of FIG. 2 the two motors are the same and each is configured to provide a substantial level of drag torque when a driver rotates the motor in an unpowered condition by rotating the handwheel. This ensures the handwheel does not spin freely in the event of a fault that removes power from the motor or where the motor has an internal fault that means the current in the windings does not generate any motoring torque in the motor. An added benefit is that more energy is consumed within the motor compared with a low drag torque motor and so there is less for the electronics to do to provide a controlled resistance, heat being dissipated within the motor rather than from the electronics

The skilled person will understand that the invention can be implemented with only one of the motors providing a substantial drag torque and the other a conventional motor used in prior art handwheel actuators with a low drag torque.

By drag torque we mean the torque arises due to energy conversion within the stator of the motor as it is rotating. Mechanical energy from the driver causes the rotor to rotate. As it rotates the rotor and stator interact magnetically generating a changing flux within the stator. This will give rise to both eddy currents and hysteresis losses and electrical energy is converted to heat as these currents pass through the resistive material forming the stator. Thus, mechanical energy is converted heat and a drag torque results.

A first construction of a motor 200 which can be used as one or both of the motors 1,11 of FIG. 1 and FIG. 2 is shown in plan view in FIG. 8. The motor 200 comprises a rotor 202 and a stator 201. The stator 201 comprises a circular yoke 201a and has a set of teeth 203 which each project radially away from the yoke. Each tooth extends axially down the stator from an upper end to a lower end. The rotor 202 fits within a void defined by the tips of these teeth 203 and has an axis that is common with the axis of the rotor yoke.

The stator comprises a stack of laminations of ferromagnetic material in the form of plates that may be stamped or otherwise cut out of a large sheet. The plates are typically steel plates. In FIG. 10 the top lamination can be seen and several edges of the remaining laminations can also be seen. The laminations are packed tightly together. A coating may be provided on the surface of each lamination to help prevent corrosion of the metal plates.

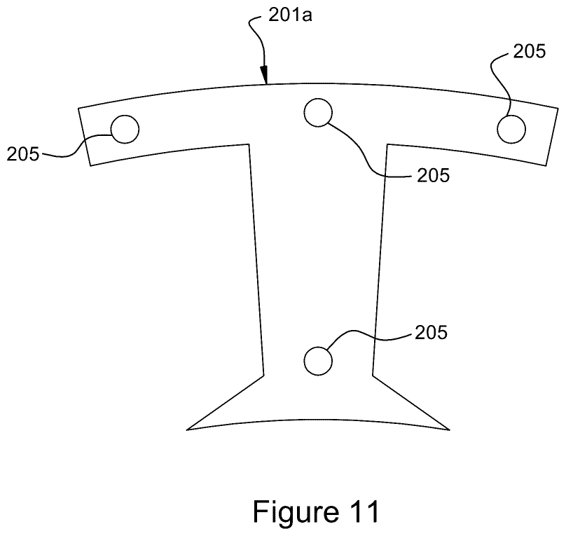

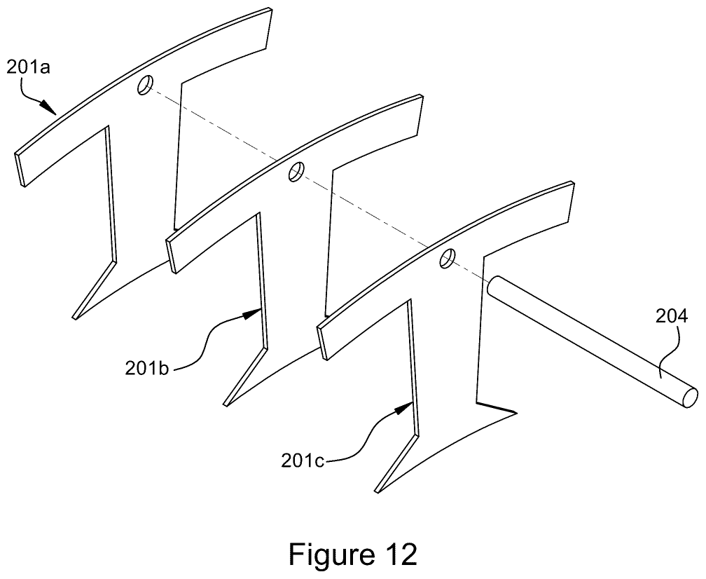

Each lamination includes three holes as shown in FIG. 11 and has a partial yoke which forms a part of a circumference of the stator, multiple stacks of plates being fixed together to form a complete stator. Of course each plate may define the whole of a yoke and carry all of the teeth of the stator.

In this example of FIG. 11 every plate has three holes in the same place and as shown in FIG. 12 these holes line up when the stack of plates is assembled. A pin 204 is then pressed into the aligned holes until it extends through the whole stack. Note that for clarity FIG. 12 shows only one pin and the corresponding holes, whereas in this example three pins are associated with each set of aligned holes. Once assembled the pins hold the stack of plates securely together as shown in FIG. 10 without the need for any additional fixings.

Each hole in this example is circular and each pin has a circular cross section that is slightly larger in diameter than the holes so that as the pin is pressed in place the pin or the plate or both deform slightly to form an interference fit.

Because the pins are electrically conductive each one has a beneficial effect of increasing the drag torque of the motor 200 compared with an identical motor with no bands. FIG. 10 also shows a number of optional welds 204 that secure the band in position relative to the tooth 203.

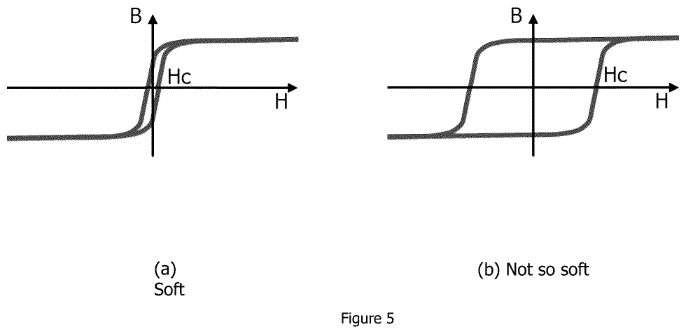

Drag torque arises for several reasons with the two primary reasons being hysteresis within parts of the motor stator and the formation of eddy currents. FIG. 5 illustrates this for a generic soft material such as electrical steel and for a generic not so soft material such as carbon steel that may be used to form the stators in the motors of FIG. 1 or FIG. 2. In each plot the area enclosed represents the loss arising from the magnetic domains reversing—the more times the steel is magnetised north & south, the larger the loss, and therefore the larger the drag torque. Steel with low hysteresis loss performs as shown in FIG. 5(a) and has a narrow hysteresis loop, steel with high hysteresis loss is shown in FIG. 5(b) and has a wider hysteresis loop and a motor fabricated using the later will have more drag torque due to more hysteresis loss.

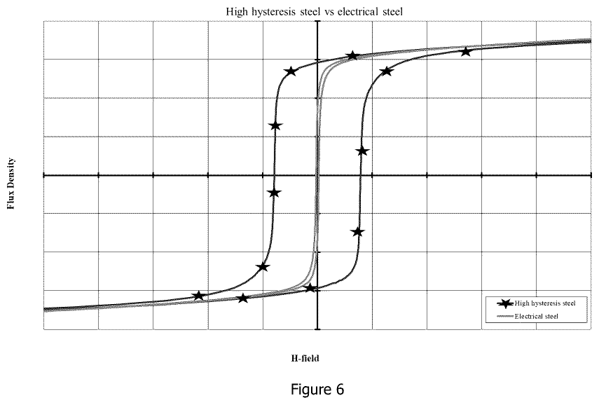

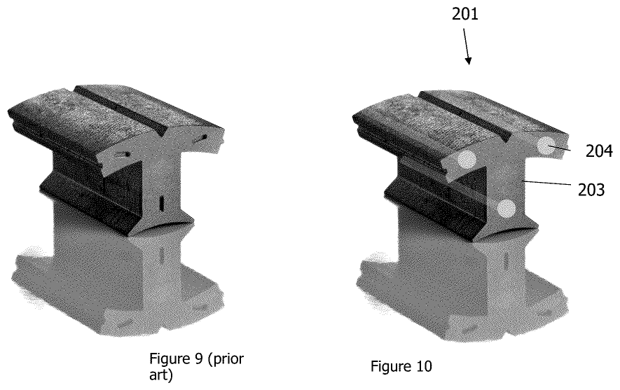

FIG. 6 illustrates the different B-H curves of a high hysteresis steel chosen for the motors of the examples of FIGS. 1 and 2, and additionally FIGS. 9 and 10, and an electrical steel that meets the M470-50 specification. The reference steel is one that falls within the specification of an electrical steel defined. The other is a more lossy steel and not so soft steel such as spring steel. The not so soft steel has considerably more hysteresis. The carbon steel measured in the graph shows approx. 30 times the coercivity and thus much higher drag torque than the electrical steel.

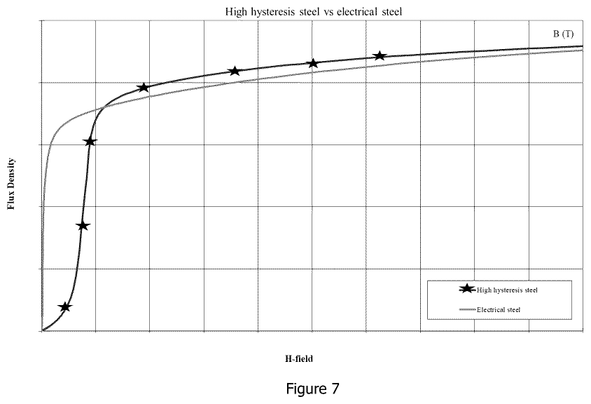

As shown in FIG. 7, the same spring steel at the flux densities of interest within a practical motor reaches at least as high flux density as the electrical steel, giving similar motor performance.

1. A motor comprising a stator and a rotor, the stator carrying a plurality of phase windings and the rotor carrying a plurality of magnet poles; and
in which the stator comprises a stack of laminations which each comprise a ferromagnetic plate, each lamination including at least one hole within the plate that is aligned with a corresponding hole in adjacent plates in the stack, and further comprising at least one electrically conductive pin that extends axially along a length of the stator passing through the aligned holes to provide a path for currents axially along the stator.

2. A motor according to claim 1 in which every lamination includes at least one hole aligned with a hole in every adjacent lamination such that the pin extends axially through the whole of the stack of laminations.

3. A motor according to claim 1 in which the pin comprises an elongate rod of ferromagnetic material such as a metal or metal alloy.

4. A motor according to claim 1 in which the pin has an interference fit with at least two plates to hold those plates together.

5. A motor according to claim 1 in which the pin is deformed at one or both ends to act as a rivet holding the lamination stack together.

6. A motor according to claim 1 in which each plate includes a second hole which is aligned with a corresponding second hole in adjacent plates and the motor further includes a second pin which passes through the aligned second holes to enhance the electrical conductivity and mechanical stability of the assembly.

7. A motor according to claim 1 in which the stator comprises a yoke from which a plurality of teeth project and in which at least one hole is formed in each layer of an end portion of every tooth of the stator aligned with corresponding holes in adjacent teeth.

8. A motor according to claim 1 in which the motor stator is configured such that the motor stator assembly excluding copper windings has an effective loss per mass of at least 30 Watts per kg.

9. A motor according to claim 1 configured to provide at least 60 percent of the resistance to rotation of the rotor for at least one speed in the range, or at least 70 percent, or 80 percent, or substantially all of the drag torque over a range of non-zero rotational speeds.

10. A motor according to claim 1 configured to provide at least 2 Nm of drag torque over a substantial range of non-zero rotational speeds of the rotor.

11. A mechanical assembly comprising:
a housing;
a shaft rotatably mounted with respect to the housing;
one or more motors each having a stator and a rotor, the stator carrying a plurality of phase windings and the rotor carrying a plurality of magnet poles and being connected to the shaft;
a control circuit adapted to control the current flowing into or out of the or each motor to cause a net torque to be applied to the shaft during normal operation, and
in which the stator comprises a stack of laminations which each comprise a ferromagnetic plate, each lamination including at least one hole within the plate that is aligned with a corresponding hole in adjacent plates in the stack, and further comprising at least one electrically conductive pin that extends axially along a length of the stator passing through the aligned holes to provide a path for currents axially along the stator.

12. A mechanical assembly according to claim 11 in which every lamination includes at least one hole aligned with a hole in every adjacent lamination such that the pin extends axially through the whole of the stack of laminations.

13. A mechanical assembly according to claim 11 including a gearbox comprising a first gear fixed relative to the shaft and a second gear fixed relative to the output of the motor, rotation of the first gear causing a rotation of the second gear.

14. A method of constructing an electric motor comprising:
providing a set of laminations, each comprising a plate having at least one hole; and
at least one elongate electrically conductive pin,
assembling the plates in a stack whereby the hole in each plate aligns with a hole in any adjacent lamination, and
inserting the pin into the stack so that it extends through each of the aligned holes.

15. A method according to claim 14 whereby the holes prior to inserting the pin are undersized relative to the size of the pin such that on inserting one or both of the pin and material surrounding each hole is deformed to provide a secure grip between the pin and the plates.

16. A method according to claim 14 comprising a step of flaring the ends of the pin after insertion to prevent removal of the pin.
